(19) United States
(12) Patent Application Publication
(10) Pub. No.: US 2005/0238899 A1
(43) Pub. Date: Oct. 27, 2005

(54) High solids clearcoat compositions containing silane functional compounds

(76) Inventors: Isao Nagata, Troy, MI (US); Leatrese Dionne Hopkins, Flint, MI (US); Michelle R. Patterson, Sterling Heights, MI (US)

Correspondence Address: E I DU PONT DE NEMOURS AND COMPANY;LEGAL PATENT RECORDS CENTER, BARLEY MILL PLAZA 25/1128, 4417 LANCASTER PIKE, WILMINGTON, DE, 19805, US

(21) Appl. No.: 10/832,749

(22) Filed: Apr. 27, 2004

(51) Int. Cl. B32B 27/36; C08L 67/00; B05D 1/36

(52) U.S. Cl. 428/480; 525/440; 427/402

(57) ABSTRACT

A rapid cure sprayable liquid coating composition containing a highly branched film-forming polyester polyol resin, a polyisocyanate crosslinking agent, and a volatile organic liquid carrier. Low molecular weight film-forming silane compounds are incorporated in the coating for better film properties, such as improved adhesion to commercially available windshield adhesives, and also for reduced spray viscosity, which leads to higher spray solids and lower volatile organic content. The coating composition can be used as a clearcoat over a pigmented basecoat to provide an attractive exterior automotive finish.

### BACKGROUND OF THE INVENTION

This invention is directed to a coating composition useful for providing a finish on a variety of substrates. In particular, this invention is directed to a high solids rapid curing coating composition which, when used as a clearcoat in a multilayer finish, provides a coating with excellent adhesion to windshield bonding adhesives.

In order to protect and preserve the aesthetic qualities of the finish on vehicles such as automobiles and trucks, it is generally known to provide a clear (unpigmented or slightly pigmented) topcoat over a colored (pigmented) basecoat, so that the basecoat remains unaffected even on prolonged exposure to the environment or weathering. This type of finish is usually referred to as a basecoat/clearcoat finish. It is also generally known that compositions that form urethane bridges when cured, due to strong urethane bonding, provide finishes with excellent resistance to etching from acid rain and other environmental pollutants, along with good scratch resistance. These coatings are widely used nowadays as clearcoats over pigmented basecoats.

Due to current pollution regulations, continuing effort has been directed to development of topcoats having low volatile organic content (VOC), without sacrificing sprayability and ease of application. Two-component rapid curing polyurethane coatings have been proposed that offer high spray solids and low VOC. However, such coatings still suffer from poor adhesion to typical moisture-curable urethane windshield bonding adhesives.

Typically, when a windshield is affixed to the body of a vehicle which has already been painted with a topcoat, an adhesive or sealant material is used to attach the windshield to the body. However, many of the commonly available moisture-curable urethane windshield adhesives, such as those described in U.S. Pat. No. 6,512,033, do not adhere well to high-solids topcoats that contain urethane groups. One solution to the problem of failure of windshield adhesives to adhere to urethane containing topcoats is to prime the topcoat with a urethane primer wherever the adhesive is to be applied. Although effective, this method adds an additional step to the process of adhering a windshield to the vehicle body.

A continuing need still exists for topcoat coating formulations that are fast curing, high in solids, and can be applied with conventional equipment and that also provide excellent adhesion to windshield bonding adhesives, while also meeting today's performance requirements, such as high gloss and DOI (distinctness of image), etch resistance, scratch and mar resistance and recoat adhesion.

The novel coating composition of this invention has the aforementioned desirable characteristics.

### SUMMARY OF THE INVENTION

The invention is directed to a sprayable, curable, high solids (low solvent), liquid coating composition having improved adhesion to certain commercially available windshield bonding adhesives. The coating composition contains about 45-100% by weight of a film-forming binder and correspondingly about 55-0% by weight of a volatile organic liquid carrier; wherein the binder contains:

(A) a curable film-forming hydroxyl containing highly branched polyester resin;

(B) an organic polyisocyanate crosslinking agent;

(C) a silane fimctional component having one or more hydrolyzable silyl groups and optional hydroxyl groups.

Components (A) and (B) are packaged separately and are combined just prior to application, because component (B) crosslinks the combined components. Component (C) provides the desired windshield bonding adhesion and can be provided to the crosslinking reaction either as part of (A) or as a separate component. The pot-life of the combined components is sufficient to enable the combined components to be applied, typically by spraying, onto the substrate to be coated, typically a vehicle body part, including the entire vehicle body.

Optionally, the coating may additionally include a melamine component that is reactive with hydroxyl groups of components (A) and (C), or with isocyanate (B) if the melamine contains imino hydrogen, to provide for additional crosslinking and a hard, tough, durable and weatherable finish within a short period of time after application.

The invention is based on the discovery that use of certain silane functional compounds in the forgoing composition improves adhesion of the cured coating to certain commercially available windshield bonding adhesives applied thereover without use of a primer in between. The term “component” as used herein with respect to component (C) includes polymers, oligomers, compounds, and mixtures thereof.

The invention also includes a method for achieving improved adhesion to windshield bonding adhesives by coating a substrate with the above coating composition and substantially or completely curing the coating thereon, followed by application of the windshield bonding adhesive and a substrate such as a vehicle body or a part thereof having adhered thereto a coating according to the above composition. The invention further includes certain novel silane functional compounds that are suited for use as adhesion promoters in a variety of high solids topcoat compositions.

The coating composition of the invention is especially useful for forming a clear topcoat over a pigmented basecoat. Such a clear topcoat can be applied over a variety of basecoats, such as water or organic solvent based basecoats or powder basecoats.

### DETAILED DESCRIPTION OF THE INVENTION

As used herein:

“Two-pack coating composition” or “Two-component coating composition” means a thermosetting composition comprising two components that are stored in separate containers, which are typically sealed for increasing the shelf life of the components of the coating composition. The components are mixed just prior to use to form a pot mix, which has a limited pot life, typically a few minutes, such as, 15 minutes to 45 minutes to a few hours, such as, 2 hours to 6 hours. The pot mix is applied as a layer of a desired thickness on a substrate surface, such as, an autobody. After application, the layer dries and cures to form a finish on the substrate surface having desired coating properties, such as mar resistance.

“Low VOC composition” means a coating composition that is less than about 0.6 kilogram of organic solvent per liter (5 pounds per gallon) of the composition, preferably in the range of less than about 0.3 kilogram of organic solvent per liter (2.5 lb/gal) and most preferably in the range of less than about 0.18 kg per liter (1.5 pounds per gallon), as determined under the procedure provided in ASTM D3960.

“High solids composition” means a low solvent coating composition having a solids content of above 45 percent, preferably in the range of from 80 to 100 percent, in weight percentages based on the total weight of the composition.

“Highly branched polyester” or “Hyper branched polyester” means a branched polyester with a degree of polyester branching on average of at least 3.

This invention relates to sprayable, high solids, low VOC, etch resistant coatings particularly useful for finishing the exterior of automobile and truck bodies and parts thereof. More particularly, this invention provides a high solids etch resistant coating that is primarily used as a clear coat over a pigmented base coat containing solid color pigments or metallic flake pigments or mixtures thereof. The coating composition also can be used as a conventional pigmented composition. The coating composition can be applied with conventional spray equipment and cured at ambient temperatures or slightly elevated temperatures which decrease drying time. The resulting finish has excellent gloss and distinctness of image and weatherability. The coating composition also offers a significant improvement over conventionally used automotive finishes in terms of spray solids and VOC and adhesion to certain commercially available moisture-cure windshield bonding adhesives applied thereover after cure.

Preferably, the coating composition is a clear coating composition, i.e., containing no pigments or a small amount of transparent pigment. The composition has a relatively high solids content of about 45-100% by weight, preferably about 80-90% by weight, of binder and about 0-55% by weight, preferably about 10-20% by weight, of a volatile organic liquid carrier which can be a solvent for the binder or a mixture of solvents and non solvent which would form a non aqueous dispersion. The composition has a low VOC (volatile organic content) and meets current pollution regulations and is also sprayable through conventional equipment regardless of its high solids content.

As indicated above, the present invention contemplates use of coating compositions having up to 100% solids content (approaching 0 VOC content). Even at such high solids levels, the coatings have sufficient low viscosity so as to enable easy application such as by spraying, without the need to employ appreciable amount of solvent.

Generally, when the novel coating composition is used for clearcoat applications, a two-pack composition is provided in which the binder component containing the highly branched polyester polyol is included in solution in the liquid carrier in one pack, typically along with the other additives, and the crosslinking component containing the polyisocyanate is included in solution in the carrier in the second pack and the two packs are mixed together just before application.

The binder of the coating composition contains about 5-70% by weight, and in one embodiment 10-50%, based on the total weight of the binder, of a film-forming hydroxyl-containing highly branched polyester resin, also referred to as a highly branched copolyester polyol.

The highly branched copolyester polyol that is useful in the practice of this invention has a number average molecular weight not exceeding 30,000, preferably in the range of from 1,000 to 30,000, more preferably in the range of 1,200 to 20,000, most preferably in the range of 1,500 to 12,000. The copolyester polyol has hydroxyl groups ranging from 5 to 200 per polymer chain, preferably 5 to 70, and more preferably 6 to 50, and carboxyl groups ranging from 0 to 40 per chain, preferably 1 to 40, more preferably 1 to 20 and most preferably 1 to 10. The Tg (glass transition temperature) of the copolyester polyol ranges from −70° C. to 50° C., preferably from −65° C. to 40° C., and more preferably from −60° C. to 30° C.

All molecular weights disclosed herein are determined by GPC (gel permeation chromatography) using polymethyl methacrylate as the standard.

The highly branched copolyester polyol is conventionally polymerized from a monomer mixture containing a chain extender selected from the group consisting of a hydroxy carboxylic acid, a lactone of a hydroxy carboxylic acid and a combination thereof; and one or more hyperbranching monomers.

Some of the suitable hydroxy carboxylic acids include glycolic acid; lactic acid; 3-hydroxycarboxylic acids, e.g., 3-hydroxypropionic acid, 3-hydroxybutyric acid, 3-hydroxyvaleric acid, and hydroxypyvalic acid.

Some of the suitable lactones include caprolactone, valerolactone; and lactones of the corresponding hydroxy carboxylic acids, such as, glycolic acid; lactic acid; 3-hydroxycarboxylic acids, e.g., 3-hydroxypropionic acid, 3-hydroxybutyric acid, 3-hydroxyvaleric acid, and hydroxypyvalic acid. Caprolactone is preferred.

Suitable hyper branching monomers include those having one carboxyl group and two hydroxyl groups, two carboxyl groups and one hydroxyl group, one carboxyl group and three hydroxyl groups, or three carboxyl groups and one hydroxyl group. The foregoing monomers can be structurally represented by the following structures wherein A is carboxyl and B is hydroxyl:

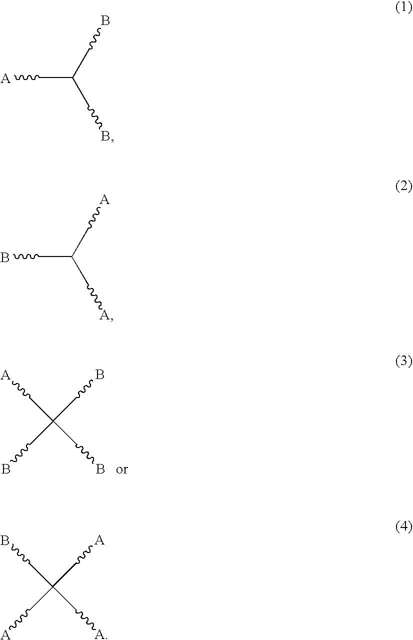

It should be noted that even though A and B groups in foregoing structures are shown in terminal position, it is contemplated these groups could be positioned anywhere in these structures. Some of the suitable hyperbranching monomers include dialkylol propionic acid, preferably dimethylol propionic acid and diethylol propionic acid; trimethylolacetic acid; citric acid; malic acid; gluconic acid; and a combination thereof.

The weight ratio of the hyper branching monomer to the chain extender in the monomer mixture ranges from 1/0.3 to 1/20, preferably from 1/1 to 1/10 and more preferably from 1/1.5 to 1/4.

The monomer mixture can further include one or more molecular weight controlling agents having in the range of 1 to 6 functionalities selected from the group consisting of hydroxyl, amine, epoxide, carboxyl and a combination thereof. Some of the suitable molecular weight controlling agents can include polyhydric alcohols, such as ethylene glycol, propanediols, butanediols, hexanediols, neopentylglycol, diethylene glycol, cyclohexanediol, cyclohexanedimethanol, trimethylpentanediol, ethylbutylpropanediol, ditrimethylolpropane, trimethylolethane, trimethylolpropane, glycerol, pentaerythritol, dipentaerythritol; polyalkylene glycol, such as, polyethylene glycol and polypropylene glycol. The preferred polyhydric alcohols are ditrimethylolpropane, trimethylolethane, trimethylolpropane and pentaerythritol.

For carboxylic acid containing hyperbranched polyesters some suitable molecular weight controlling agents include polyepoxides such as, glycidyl esters, for example, Araldite®CY-184 from Ciba Specialty Chemicals, Tarrytown, N.Y., cycloaliphatic epoxides and sorbitol gylcidyl ethers. Others that can be used are glycidyl ethers of Bisphenol A, epichlorohydrine-polyols and epoxidized polyunsaturated compounds, e.g., epoxidized natural oils and epoxidized polybutadienes and a diol having one primary hydroxyl and one secondary or tertiary hydroxyl group, such as 2-ethyl,1,3-hexane diol, 1,3-butane diol, 1,2-propane diol, or combination thereof; or a combination of the polyepoxy and diol to provide the highly branched copolyester polyol with the described range of hydroxyl groups.

Other suitable molecular weight controlling agents are polyamines, such as ethylene diamine, hexamethylene diamine, diethylene triamine, and PACM diamine supplied by Airproducts Inc., Allentown, Pa., or combinations thereof; and polycarboxylic acids, such as, adipic, azelaic and dodecanedioic or combinations thereof. The carboxylic acids can have, for example, two carboxyl groups and two hydroxyl groups, such as tartaric acid.

Capping reactions can be used to change the functionality, solubility or cure of the hyperbranching component. Reactions include monohydric alcohols, such as methanol, ethanol, cyclohexanol and 2-ethylhexanol. to convert acid groups to esters; monocarboxylic acids such as acetic, propionic or hexanoic to convert alcohol groups to esters; monoamines, such as butyl amine, hexyl amine, and cyclohexyl amine to convert carboxylic acid groups to amides; monoepoxides, such as ethylene oxide, propylene oxide, epoxy butanes, such as epoxycyclohexane, epoxydecane, glycidyl methacrylate copolymers and Glydexx® N-10, a mixed glycidyl ester from Exxon Chemicals, Houston, Tex. to convert carboxylic acid functionality to ester/hydroxyl and monoisocyanates, such as phenyl isocyanate or cyclohexyl isocyanate to convert hydroxyl groups to carbamate and amine groups to urea.

It should be understood that by controlling the amount of monoepoxy or monohydric alcohol used for post-reaction, some of the carboxyl groups on the resulting highly branched copolyester polyol can be left intact, thus providing the highly branched copolyester polyol with a desired range of carboxyl groups.

Two preferred highly branched copolyester polyols are (1) the reaction product of dimethylol propionic acid and caprolactone, and (2) the reaction product of dimethylol propionic acid, caprolactone and pentaerythritol. These polyols produce coating compositions that form coatings having excellent mar resistance, excellent flexibility and rapid cure.

The monomer mixture preferably includes dialkylol propionic acid, such as dimethylol propionic acid and caprolactone. The more preferred monomer mixture further includes pentaerythritol, trimethylol propane or more preferably pentaerythritol. A coating composition containing the resulting highly branched copolyester polyol forms coatings that have excellent mar resistance, excellent flexibility and rapid cure.

The highly branched copolyester polyol can be produced by polymerizing, in one step, the monomer mixture that includes the chain extender and the highly branched monomers. If desired, the monomer mixture in the foregoing one step random polymerization process can also include the molecular weight controlling agent.

Alternatively, the highly branched copolyester polyol can be produced in stages by first polymerizing the highly branched monomers followed by polymerizing the chain extender. Thus, in the first step, the monomer mixture, which includes the highly branched monomers, is polymerized and then in the second step, the polymerization is continued with the addition of the chain extender.

In another alternative, the highly branched copolyester polyol is produced in stages by first polymerizing the molecular weight controlling agent and the highly branched monomers followed by polymerizing the chain extender. Thus, in the first step, the monomer mixture, which includes the highly branched monomers and the molecular weight controlling agent, is polymerized and then in the second step, the polymerization is continued with the addition of the chain extender.

Still another modification of the foregoing process includes producing the highly branched copolyester polyol in stages by first polymerizing the molecular weight controlling agent and the highly branched monomers and a portion of chain extender followed by polymerizing the remainder of the chain extender.

The foregoing two step can be modified by first polymerizing the highly branched monomers and a portion of chain extender followed by polymerizing the remainder of the chain extender.

In still another alternative, the highly branched copolyester polyol is produced in stages by first polymerizing the molecular weight controlling agent and a portion of the highly branched monomers and a portion of chain extender followed by polymerizing the remainder of the highly branched monomers and chain extender.

In still another alternative, the highly branched copolyester polyol is produced in stages by first polymerizing portions of the molecular weight controlling agent, highly branched monomers and chain extender followed by polymerizing the remainder of said molecular weight controlling agent, highly branched monomers and chain extender.

The highly branched copolyester polyol by the aforedescribed processes can be prepared by a batch process or by a continuous polymerization process.

Generally, the aforedescribed processes for forming the copolyester polyol take place at reaction temperatures in the range of from 60° C. to 200° C. and preferably, in the range of from 80° C. to 170° C.; with typical reaction times ranging from 1 hour to 24 hours, preferably 1 hour to 4 hours. The polymerization can be catalyzed by conventional polyester catalysts, such as tin (II) di (2-ethylhexanoate)(Sn(O₂CC₇H₁₅)₂).

The coating composition of the present invention also includes a polyisocyanate crosslinking agent. For a two-component system, any of the conventionally used organic polyisocyanate crosslinking agents can be used as the crosslinker without particular limitation so long as the isocyanate compound has at least two isocyanate groups in the one molecule. The preferable polyisocyanate compounds are isocyanate compounds having on average 2 to 6 isocyanate groups per molecule.

Typical examples of polyfunctional organic isocyanate compounds are, for instance, 1,6-hexamethylene diisocyanate, isophorone diisocyanate, 2,4-toluene diisocyanate, diphenylmethane-4,4′-diisocyanate, dicyclohexylmethane-4,4′-diisocyanate, tetramethylxylidene diisocyanate, and the like. Trimers of diisocyanates also can be used such as the trimer of hexamethylene diisocyanate (isocyanurate) which is sold under the tradename Desmodur® N-3390, the trimer of isophorone diisocyanate (isocyanurate) which is sold under the tradename Desmodur® Z-4470 and the like. Polyisocyanate functional adducts can also be used that are formed from any of the forgoing organic polyisocyanate and a polyol. Polyols such as trimethylol alkanes like trimethylol propane or ethane can be used. One useful adduct is the reaction product of tetramethylxylidene diisocyanate and trimtheylol propane and is sold under the tradename of Cythane® 3160. When the crosslinkable resin of the present invention is used as a clear topcoat, the use of an aliphatic or cycloaliphatic isocyanate is preferable to the use of an aromatic isocyanate, from the viewpoint of weatherability and yellowing resistance.

Typically the polyisocyanate and hydroxyl components are employed in the coating composition in an equivalent ratio of isocyanate groups to hydroxyl groups in the range of about 0.5/1 to 3.0/1, preferably in the range of about 0.8/1 to 1.5/1. Typically this translates into the polyisocyanate crosslinking agent used in the coating composition in an amount ranging from about 5-50% by weight, preferably 15-35%, based on the weight of the binder.

A key component of the composition of the present invention is the silane component. This material can be a non-polymeric compound or an oligomeric material that contains at least two reactive (i.e., crosslinkable) sites, at least one of which is a hydrolyzable (i.e., moisture curable) silyl group. Low molecular weight materials, such as oligomeric or non-polymeric materials are especially preferred. By “oligomeric”, it is meant polymers having a number average molecular weight below 5000. These small molecules not only enable windshield bonding adhesion, but also enable in conjunction with the branched polyester, formulation of very low VOC coating compositions, since they provide decreased viscosity which helps lower VOC and raise the spray solids.

Such oligomers or non-polymeric silane functional compounds will generally have a number average molecular weight less than 5000, preferably in the range of about 200-3,500, and more preferably from about 250-2,500. These materials can be prepared in a variety of ways as described below.

To achieve primerless (i.e., direct) adhesion of the coating composition after cure to commercially available windshield sealants, as is generally desired in the present invention, a suitable amount of silane material is added to the coating composition. A suitable amount of silane material in the coating is typically 0.1 to 20%, preferably 1 to 10%, more preferably 2 to 5% by weight, based on the weight of the binder.

This silyl-group containing component can be selected from at least one of the following groups 1 to 5.

1) Silyl-containing vinyl monomers reacted with linear or branched hydroxyl containing acrylate or methacrylate.

2) Alkyl silicates reacted with a polyol.

3) Amino-functional silanes reacted with cyclic carbonate.

4) Epoxy-functional silanes reacted with monocarboxylic acid.

5) Other disilyl compounds as taught in U.S. Pat. No. 6,268,456, all of which are hereby incorporated by reference.

It should be understood that the forgoing reactions need not go to completion provided the product contains at least two hydrolysable silyl groups.

Group (1) silyl-containing compounds that can be used are silyl-containing acrylic oligomers having a 500-5,000 number average molecular weight, preferably less than 1,500.

The silyl group-containing acrylic oiligomer can be prepared by standard solution polymerization techniques in hydrocarbon solvent, in the presence of a polymerization initiator and a chain transfer agent to control the molecular weight. Preferably, the silyl group-containing acrylic polymer is the polymerization product of about 0-95%, preferably 30-50%, by weight ethylenically unsaturated linear or branched non-silane containing monomers and about 5-100%, preferably 50-70%, by weight of ethylenically unsaturated silane-containing monomers, based on the weight of the acrylic silane oligomer. Suitable ethylenically unsaturated non-silane containing monomers are alkyl acrylates, alkyl methacrylates, and any mixtures thereof, where the alkyl groups have 1-12 carbon atoms, preferably 3-8 carbon atoms. The acrylic silane oligomer can also, and preferably does, comprise hydroxy functional groups (preferably up to about 40% by weight, based on the weight of the non-silane component) which can be provided by hydroxy alkyl acrylates and methacrylates having 1-4 carbon atoms in the alkyl group such as hydroxyethyl acrylate, hydroxypropyl acrylate, hydroxybutyl acrylate, hydroxyethyl methacrylate, hydroxypropyl methacylate, hydroxybutyl methacrylate, and the like. Hydroxy functional groups are used to impart additional crosslinking functionality to the silane component. A suitable silane containing monomer useful in forming the acrylic silane oligomer is an alkoxysilane having the following structural formula:
CH₂═C(R³)—C(O)OCH₂—(CH₂)ₙ—CH₂—Si(OR¹)(OR²)(R)
wherein:
R is either CH₃, CH₃CH₂, CH₃O, or CH₃CH₂O;
R¹ and R² are independently selected from CH₃ or CH₃CH₂;
R³ is either H, CH₃, or CH₃CH₂; and
n=0 or positive integer form 1 to 10.
Preferably, R is CH₃O or CH₃CH₂O and n is 1.

Group (2) silicates that may be used in the coating composition of the present invention include the reaction product of a polyol of the formula
R¹—(OH)ₙ
with
   (SiXₙY₄)ₙ
the reaction product having a number average molecular weight less than about 5,000, preferred less than about 2,500;
wherein:
R¹ is selected from the group consisting of
a) C₂ to C₂₀ alkyl, C₃ to C₂₀ cycloaliphatic or C₆ to C₂₀ cycloaromatic rings, each optionally substituted with at least one member selected from the group consisting of O, N, P and S;
b) two or more cycloaliphatic or aromatic rings connected to each other through a covalent bond or through an alkylene group of 1 to 5 carbon atoms, or through a heteroatom, or fused together to share to or more carbon atoms, each optionally substituted with at least one member selected from the group consisting of O, N, P and S; and
c) linear polyester, branched polyester, linear and branched polyester, polyacrylate, polyolefin, polyether, polycarbonate, polyurethane, or polyamide;
X is independently selected from the group consisting of alkoxy containing 1 to 20 carbon atoms, acyloxy containing 1 to 20 carbon atoms, phenoxy, halogen, amine, amide, urea, imidazole, carbamate, ketoximine, and oxazolidinone;
Y is selected from the group consisting of alkyl of 1 to 12 carbon atoms, alkoxy containing 1 to 20 carbon atoms, acyloxy containing 1 to 20 carbon atoms, phenoxy, halogen, amine, amide, urea, imidazole, carbamate, ketoximine, and oxazolidinone;
m is a positive integer of 2 or higher, preferred 2 to 30; and
n is 0, 1 or 2.

Group (3) silyl-containing compounds that can be used are the reaction product of a cyclic carbonate of the formula 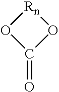
with an amino-functional silane of formula
   R²NH(R³)ₘSi(OR¹)₃
the reaction product having a number average molecular weight less than about 5,000, preferred less than about 2,500;
wherein:
R is an alkylene group;
R¹ is independently C₁-C₁₆ alkyl;
R² is independently H or C₁-C₁₂ alkyl;
R³ is a moiety independently selected from the group consisting of alkylene, cycloalkylene, heterocyclic, arylene, alkoxylene, aralkylene, alkenylene, cycloalkylene and low molecular weight polymer moiety;
n is an integer of 2 or 3; and
m is 1 to 16.

In the formula above, representative low molecular weight polymer values for R³ are polyester, polyurethane, polyether, polyamine and the like. Preferred for R¹ are alkyls of C₁ to C₄, most preferably C₁ to C₂. Alkyl substituents can be linear or cyclic and the amine function can be primary or secondary. For R³, by “low molecular weight” is meant no more than about 3000 (number average). When R³ is a low molecular weight polymer, m=1.

Group (4) silyl-compounds that can be included in the silyl group containing component of the coating composition of the present invention are the reaction product of a carboxylic acid of the formula
R′—C(O)OH

with an epoxy-functional silane of the formula
ZSiXₙY₃₋ₙ

the reaction product having a number average molecular weight less than about 5,000, preferred less than about 2,500;
wherein:
R′ is selected from the group consisting of

a) C₂ to C₂₀ alkyl, cycloaliphatic or cycloaromatic rings, each optionally substituted with at least one member selected from the group consisting of O, N, P and S;

b) two or more cycloaliphatic or aromatic rings connected to each other through a covalent bond or through an alkylene group of 1 to 5 carbon atoms, or through a heteroatom, or fused together to share two or more carbon atoms, each optionally substituted with at least one member selected from the group consisting of O, N, P and S; and

c) linear polyester, branched polyester, linear and branched polyester, polyacrylate, polyolefin, polyether, polycarbonate, polyurethane, or polyamide;

X is independently selected from the group consisting of alkoxy containing 1 to 20 carbon atoms;

Y is selected from the group consisting of alkyl of 1 to 12 carbon atoms, alkoxy containing 1 to 20 carbon atoms;

Z is an epoxy group containing C₃ to C₂₀ carbon atoms, optionally substituted with O or P; and

n is 0 or 1.

For the Group (5) disilyl compounds useful herein, reference can be made to U.S. Pat. No. 6,268,456, previously incorporated by reference herein.

Of course, mixtures of the above-mentioned silane compounds are also suitable for use herein.

The coating composition of this invention can include a number of other ingredients to enhance preparation of the composition as well as improve final properties of the coating composition and the final film finish. For example, it is often desirable to include an additional crosslinking agent, for example, any of the conventionally used alkylated melamine formaldehyde crosslinking agents, in the coating composition to boost the cure rate and film integrity.

Typical alkylated melamine formaldehyde resins, commonly referred to as melamines, include any of the conventional monomeric or polymeric alkylated melamine formaldehyde resin that are partially or fully alkylated. One useful crosslinking agent is a methylated and butylated or isobutylated melamine formaldehyde resin that has a degree of polymerization of about 1-3. Generally, this melamine formaldehyde resin contains about 50% butylated groups or isobutylated groups and 50% methylated groups. Such crosslinking agents typically have a number average molecular weight of about 300-1500.

Examples of commercially available resins are of the forgoing type are commercially available from Cytec Industries, Inc. under the trademark Cymel® and from Solutia, Inc. under the trade name Resimene®.

Preferably, the additional crosslinking agent, if present is used in the amount of about 15-50% by weight, based on the weight of the binder.

If desired, although not preferred, other film-forming and/or crosslinking solution polymers may be included in the present composition. Examples include conventionally known acrylics, cellulosics, urethanes, polyesters, epoxies or mixtures thereof.

In addition to the above components, a non-aqueous dispersed (NAD) polymer may optionally be included in the coating composition. Polymers dispersed in an organic (substantially non-aqueous) medium have been variously referred to, in the art, as a non-aqueous dispersion (NAD) polymer, a non-aqueous microparticle dispersion, a non-aqueous latex, or a polymer colloid. In general, the non-aqueous dispersed polymer is characterized as a polymer particle dispersed in an organic media, which particle is stabilized by what is known as steric stabilization. Steric stabilization is accomplished by the attachment of a solvated polymeric or oligomeric layer. at the particle-medium interface.

The dispersed polymers are known to solve the problem of cracking typically associated with clear coatings, particularly coatings containing silane compounds, and are used in an amount varying from about 0 to 50% by weight, preferably about 10 to 20%, of total weight of resin solids in the composition. To accommodate high concentrations of dispersed polymers, it is desirable to have reactive groups (e.g., hydroxy groups) on the solvated portion of the dispersed polymer, which reactive groups make the polymer arms compatible with the continuous phase of the system.

Typically useful NAD polymers (NAD) comprise in the range of from about 10 to 90%, preferably in the range of from 50 to 80% all in weight percent based on the weight of the dispersed polymer, of a core formed from high molecular weight polymer having a number average molecular weight of about 50,000 to 500,000, preferably in the range of from 50,000 to 200,000, more preferably in the range of from 50,000 to 150,000. The arms make up about 10 to 90%, preferably 10 to 59%, all in weight percent based on the weight of the dispersed polymer. The arms are formed from a low molecular weight polymer having number average molecular weight of in the range of from about 1,000 to 30,000, preferably in the range of from 3000 to 20,000, more preferably in the range of from 3000 to 15,000.

The core of the dispersed acrylic polymer is comprised of polymerized acrylic monomer(s) optionally copolymerized with ethylenically unsaturated monomer(s). Suitable monomers include styrene, alkyl (meth)acrylate having alkyl carbon atoms in the range of from 1 to 18, preferably in the range of from 1 to 12; ethylenically unsaturated monocarboxylic acid, such as, (meth)acrylic acid, and silane-containing monomers. Other optional monomers include hydroxyalkyl (meth)acrylate or acrylonitrile. Optionally, the core may be crosslinked through the use of diacrylates or dimethacrylates, such as, allyl methacrylate or through post reaction of hydroxyl moieties with polyfunctional isocyanates.

The macromonomer arms attached to the core may be polymerized from monomers, such as alkyl (meth)acrylates having 1 to 12 carbon atoms. Typical hydroxy-containing monomers are hydroxy alkyl (meth)acrylates, described above. Specific examples of NAD polymers are disclosed in the following US Patents which are hereby incorporated by reference: U.S. Pat. Nos. 4,849,480, 5,010,140, 5,763,528 and 6,221,494.

A catalyst is typically added to catalyze the crosslinking of the silane moieties of the silane polymer with itself and with other components of the composition, including the NAD polymer, if present. Typical of such catalysts are dibutyl tin dilaurate, dibutyl tin diacetate, dibutyl tin dioxide, dibutyl tin dioctoate, tin octoate, aluminum titanate, aluminum chelates, zirconium chelate, bismuth complex, and the like. Tertiary amines and acids or combinations thereof are also useful for catalyzing silane and hydroxy-isocyanate bonding. Typical of such catalysts are sulfonic acids, such as dodecylbenzene sulfonic acid, either blocked or unblocked, are effective catalysts. Typical blocked acid catalyst are dodecyl benzene sulfonic acid blocked with an amine, such as amino methyl propanol or dimethyl oxazolidine. Other useful catalysts will readily occur to one skilled in the art. Preferably, these catalysts are used in the amount of about 0.1 to 5.0%, based on the weight of the binder.

To improve weatherability of a finish produced by the present coating composition, an ultraviolet light stabilizer or a combination of ultraviolet light stabilizers can be added in the amount of about 0.1-5% by weight, based on the weight of the binder. Such stabilizers include ultraviolet light absorbers, screeners, quenchers, and specific hindered amine light stabilizers. Also, an antioxidant can be added, in the about 0.1-5% by weight, based on the weight of the binder.

Typical ultraviolet light stabilizers that are useful include benzophenones, triazoles, triazines, benzoates, hindered amines and mixtures thereof. Specific examples of ultraviolet stabilizers are disclosed in U.S. Pat. No. 4,591,533, the entire disclosure of which is incorporated herein by reference.

The composition may also include other conventional formulation additives such as flow control agents, for example, such as Resiflow® S, available from ChemCentral, Chicago, Ill., (BYK® 320 and 325, available from BYK-Chemie, Wallingford, Conn., (rheology control agents, such as fumed silica; water scavengers such as tetraalkylsilicate, trimethyl orthoformate, triethyl orthoformate and the like.

When the present composition is used as a clearcoat (topcoat) over a pigmented colorcoat (basecoat) to provide a colorcoat/clearcoat finish, small amounts of pigment can be added to the clear coat to eliminate undesirable color in the finish such as yellowing.

The present composition also can be pigmented and used as the colorcoat, or as a monocoat or even as a primer or primer surfacer.

When the present coating composition is used as a basecoat, typical pigments that can be added to the composition include the following: metallic oxides such as titanium dioxide, zinc oxide, iron oxides of various colors, carbon black, filler pigments such as talc, china clay, barytes, carbonates, silicates and a wide variety of organic colored pigments such as quinacridones, copper phthalocyanines, perylenes, azo pigments, indanthrone blues, carbazoles such as carbazole violet, isoindolinones, isoindolones, thioindigo reds, benzimidazolinones, metallic flake or other special effect pigments such as aluminum flake, pearl flakes and the like.

The pigments can be introduced into the coating composition by first forming a millbase or pigment dispersion with any of the aforementioned polymers used in the coating composition or with another compatible polymer or dispersant by conventional techniques, such as high speed mixing, sand grinding, ball milling, attritor grinding or two roll milling. The mill base is then blended with the other constituents used in the coating composition.

Conventional solvent(s) and diluent(s) are generally employed as the organic liquid carrier to disperse and/or dilute the above mentioned polymers to obtain the present liquid coating composition. Typical solvents and diluents include toluene, xylene, butyl acetate, acetone, methyl isobutyl ketone, methyl ethyl ketone, methanol, isopropanol, butanol, hexane, acetone, ethylene glycol, monoethyl ether, VM and P naphtha, mineral spirits, heptane and other aliphatic, cycloaliphatic, aromatic hydrocarbons, esters, ethers and ketones and the like. The amount of organic solvent depends upon the desired solids level as well as the desired amount of VOC of the composition. If desired, organic solvent may be added to both components of the composition when it is supplied in two-pack form, as is preferred.

Since the present composition is based on oligomers and non-polymeric compounds, as indicated above, much less solvent is required to formulate a sprayable coating that meets automotive finish performance requirements, when compared to conventional automotive coatings.

If desired, the amount of organic solvent used in the present invention can be adjusted to less than 0.6 kilogram (5 pounds per gallon) and in one embodiment in the range of 0.012 kilogram to 0.53 kilogram (0.1 pounds to 4.4 pounds per gallon), and in another embodiment in the range of from 0.12 kilogram to 0.42 kilogram (1.0 to 3.5 pounds per gallon) of organic solvent per liter of the composition.

The solids level of the coating of the present invention can vary in the range of from about 45% to 100%, in one embodiment in the range of from about 50 to 95% and more, in another emodiment in the range of from about 60 to 90% all percentages being based on the total weight of the coating composition.

An advantage of the coating composition of this invention is that the VOC content can easily be adjusted to less than 0.18 kilogram per liter (1.5 pounds per gallon), and a solids content of from about 80 to 100% by weight, based on the total weight of the composition. Even at such low solvent levels, these compositions are usually a flowing liquid at room temperature and have sufficient low viscosity so that they can be easily applied, such as by spraying, with existing equipment located in automobile and truck assembly plants.

The coating composition of the present invention is preferably supplied in the form of a two-pack coating composition in which the first-pack includes the binder component and the second pack includes the crosslinking component containing polyisocyanate. Generally the first and the second pack are stored in separate containers and mixed before use. The containers are preferably sealed air tight to prevent degradation during storage. The mixing may be done, for example, in a mixing nozzle or in a container. When the crosslinking component contains the polyisocyanate, the curing step can take place under ambient conditions, or if desired, it can take place at elevated baking temperatures.

If the crosslinking component contains melamine, the melamine should be stored in the first-pack to avoid the reaction of alcohol in the melamine with isocyanate or the possible reaction of imino hydrogen in the melamine with isocyanate at room temperature.

A layer of the potmix is typically applied to a substrate by conventional techniques, such as, spraying, electrostatic spraying, roller coating, dipping or brushing. If used as a clear coating, a layer having a thickness in the range of from 25 micrometers to 75 micrometers (1-3 mils thick) is applied over a metal substrate, such as, automotive body, which is often pre-coated with other coating layers, such as an electrocoat, primer and a basecoat. The two pack coating composition may be dried and cured at ambient temperatures or may be baked upon application for about 10 to 60 minutes at baking temperatures ranging from about 80° C. to 160° C. The mixture can also contain pigments and can be applied as a monocoat or a basecoat layer over a primed substrate.

The coating composition of the present invention is suitable for providing coatings on a variety of substrates, such as metal, plastic, composite, wood and concrete substrates. The present composition is especially suitable for providing clear coatings in automotive OEM or refinish applications typically used in coating autobodies.

When the composition is used in automotive finishing applications as a clearcoat over a vehicle body, it is applied over the colorcoat which may be dried to a tack-free state and cured or preferably flash dried for a short period before the clearcoat is applied. The colorcoat/clearcoat finish is then baked as mentioned above to provide a dried and cured finish.

It is customary to apply a clear topcoat over a basecoat by means of a “wet-on-wet” application, i.e., the topcoat is applied to the basecoat without curing or completely drying the basecoat. The coated substrate is then heated for a predetermined time period to allow simultaneous curing of the base and clear coats.

These compositions have excellent properties, such as, mar resistance, gloss, DOI (Distinctness of Image), rapid cure, low VOC, and excellent adhesion directly to windshield bonding adhesives, especially those containing active silane groups.

### Testing Procedures Used in the Examples

The following test procedures were used for generating data reported in the examples below:

20° Gloss—test method ASTM D523—a rating of at least 80 is an acceptable minimum.

Hardness—Tukon Hardness—test method ASTM D1474.

QMS Measurement

The QMS Meter (from Autospect Co., Ann Arbor, Mich.) provides measurement of DOI (sharpness) gloss (luster), orange peel (waviness), and a combined value representing a composite number based on percentages of the sharpness, luster and waviness of the surface. This rating has a high correlation with visual perception.

Dry Mar Resistance

The clear coating of the panel was coated with a thin layer of Bon Ami abrasive supplied by Faultless Starch/Bon Ami Corporation, Kansas City, Mo. The panels were then tested for mar damage by applying 10 double rubs against a green felt wrapped fingertip of A.A.T.C.C. Crockmeter (Model CM-1, Atlas Electric Devices Corporation, Chicago, Ill.). The dry mar resistance was recorded as percentage of gloss retention by measuring the 20° gloss of the mar areas versus the non-marred areas of the coated panels.

Wet Mar Resistance

Similar procedure was used as above except that a wet alumina slurry was used instead of the Bon Ami abrasive. The alumina slurry consisted of 294 parts deionized water, 21 parts ASE-60 Thickener, 25 parts AMP 95% aqueous solution of amino methyl propanol and 7 parts of aluminum oxide (120# grit).

No Sand Recoat Adhesion Test

Recoat adhesion was determined by applying two coats of the coating composition. The second coat was applied without sanding the first coat of paint after it was baked. The baking conditions of the first coat that was applied were 160° C. (320° F.) for 1 hour and the baking conditions of the second coat were 130° C. (265° F.) for 30 minutes. The coating on the panel was then cross cut and tape applied and removed and the amount of coating removed was rated.

Quick Knife MVSS Windshield Sealant Adhesion Test

A bead of windshield adhesive was applied to the clearcoat surface after baking. The windshield adhesive used is commercially available from Dow Essex Specialty Products Company. Approximately a 5 mm×5 mm×250 mm adhesive bead was placed on the cured clearcoat surface. The adhesive plus clear composite was cured for 72 hours at about 75° F. (24° C.) and 20-50% relative humidity. The cured adhesive bead was cut with a razor blade. A cut was made through the adhesive bead at a 60° angle at 12 mm intervals while pulling back the edge of the adhesive at a 180°angle. A minimum of 10 cuts was done for each system. The desired result is described as 100% cohesive failure (CF) and 0% adhesive failure (AF). Cohesive failure (CF) occurs when the integrity of the adhesive bead is lost as a result of cutting and pulling rather than the bond between the adhesive bead and the clearcoat surface which indicates adhesive failure (AF).

The following examples illustrate the invention. All parts and percentages are on a weight basis unless otherwise indicated. Molecular weights are determined by GPC (Gel Permeation Chromatography) using polymethyl methacrylate as the standard.

### EXAMPLES

The following resins were prepared and used as indicated in the Clearcoat Examples described hereinafter.

### Silane Example 1

### Preparation of Dual-Functional Acrylic Oligomer Containing Silane and Hydroxy Groups

In a reaction flask equipped with a trap, mixer, and a condenser, 69 g of aromatic hydrocarbon (Aromatic 100 from ExxonMobil Chemicals Co, Houston, Tex.) and 55 g pf butanol were charged and heated to reflux (120-125° C.). A mixture of 59 g of styrene, 71 g of isobutyl methacrylate, 59 g of hydorxypropyl acrylate, 18 g of N-butyl acrylate, and 384 g of gamma-methacryloxypropyl trimethoxysilane and a mixture of 85 g of aromatic hydrocarbon and 47 g of 2,2′-azobis(2-methylbutylonitrile) were simultaneously added to a reactor over a period of 300 minutes. The reaction mixture was held for 1 hour to yield a polymer solution with 71% solid and Gardner-Holdt viscosity of L+1/2.

### Silane Example 2

### Reaction Product of Propylene Carbonate and 3-methoxysilyl-1 -propanamine

A mixture of 288.1 g of propylene carbonate (Jeffsol PC from Huntsman Chemical Co. Houston Tex.) and 491.3 g of 3-methoxysilyl-1-propanamine (Silane A-1110 from Crompton, Osi Specialities) was heated to 98-101° C. for 4 hours under a nitrogen gas blanket in a flask equipped with a mixer and a gas inlet. Then, 44.6 g of butyl alcohol was added to a reaction mixture at a mixture temperature of 100° C. or lower while cooling. The product had solids of 84% and a Brookfield viscosity of 150 cp ( at 5 rpm and 25° C.).

### Silicate Example 3

### Reaction Product of Polyol with Alkoxy Silicate

A mixture of 1,4-cyclohexanedimethanol (520 g, 3.61 mole), tetramethoxysilicate (1200 g, 7.88 mole), and trifluoroacetic acid (15 g, 0.132 mole) was heated at 65-70° C. in a three-liter flask equipped with a magnetic stirrer, and solvent recovery head under nitrogen blanket. After 24 hours, 210 mL of distillate was collected. Volatiles (437 g) were removed in 1 hour at 65° C. under vacuum (20 torr) on a rotary evaporator. More volatiles (44 g) were removed in 12 hours at 65° C. under high vacuum (0.1 torr). The colorless liquid had viscosity of 0.7 poise at 25° C.

### Silane Example 4

### Preparation of a Dual Functional Silane From an Epoxy-Functional Silane

A mixture of 3-glycidoxypropyltrimethoxysilane (3GPTMS) (120 g, 0.51 mole) and cylcohexnecarboxylic acid (50 g, 0.39 mole) was reacted in a closed container in an oven at around 100° C. the reaction was followed by the acid number decrease. The acid numbers were 59 after 16 hours, 50 after 38 hours, 42 after 56 hours, 38 after 75 hours and 31 after 103 hours. A yield of 155 g product was obtained. The product was colorless liquid having a viscosity of 45 cP, containing <15% of starting 3-GPTMS monomer, as measured by GC. The product theoretical hydroxy equivalent weight was 436 and silane equivalent weight was 336. The oligomers showed good stability, with a viscosity of 50 cP after 99 days stored in a closed container under nitrogen at room temperature.

### Polyester Example 5

### Preparation of a Highly Branched Copolyester Polyol

A highly branched copolyester polyol was synthesized by esterifying dimethylolpropionic acid, pentaerythritol, and gamma-caprolactone as follows:

The following constituents were charged into a reactor equipped with a mechanical stirrer, thermocouple, short path distillation head with a water separator under nitrogen flow:

| | |
|---|---|
| Dimethyolpropionic acid (DMPA) | 2127.8 |
| Pentaerythritol (PE) | 344.7 |
| Tin (11) 2-ethylhexanoate | 37.8 |
| gamma-Caprolactone (CL) | 1418.5 |
| Xylene | 121.5 |

The reaction mixture was heated to its reflux temperature and the water of reaction was collected from the water separator. The reaction progress was monitored by the amount of water collected, and the reaction temperature was not allowed to exceed 185° C. An additional 20 g of xylene was added throughout the reaction to maintain the reflux temperature below 185° C. When the amount of water collected approached theoretical amount of 286 g, acid number measurements were used to determine the end point that was an acid number of less than 5. At a measured acid number of 1.5, the reactor was allowed to cool to 120° C. Then, 2837.2 g of gamma-caprolactone was added slowly over a 15-20 minute period through an additional funnel. The reactor was held at 120° C. until reaction solids exceeded 95%. Then the reactor was allowed to cool to 90° C. and the resulting polymer solution was thinned with 598.2 g of ethyl 3-ethoxypropionate. Forced air was used to cool the reactor to below 50° C.

The polymer had an number-average molecular weight of 3210 (determined by GPC using PMMA as a standard with an SEC low molecular weight column), an OH # equal to 195.5, and a calculated hydroxy equivalent weight of 246.5. The polymer solution had a 91.4% solids content, a Gardner-Holdt viscosity of Z 3+1/2, and the final acid number was 0.9 corrected for solid.

### Clearcoat Examples 1-4 and Comparative Example

### Preparation of Clearcoat Compositions

Clearcoat compositions of Examples 1-4 and the Comparative Example (Control) were prepared as follows:

| | Example 1 | Example 2 | Example 3 | Example 4 | Comp. Ex. |
|---|---|---|---|---|---|
| | Parts by | Parts by | Parts by | Parts by | Parts by |
| | Weight | Weight | Weight | Weight | Weight |
| Part 1 | | | | | |
| Silane¹ | 4.69 | | | | — |
| Silane² | | 5.88 | | | — |
| Silicate³ | | | 5 | | — |
| Silane⁴ | | | | 5 | — |
| 2-Ethyl-1,3- | 4 | 4 | 4 | 4 | 4 |
| hexanediol | | | | | |
| 2-Ethylhexanol | 2 | 2 | 2 | 2 | 2 |
| Melaime⁵ | 37.1 | 35.22 | 35.22 | 35.22 | 40.78 |
| UV/HALS⁶ | 7.5 | 7.5 | 7.5 | 7.5 | 7.5 |
| Flow Aid⁷ | 1 | 1 | 1 | 1 | 1 |
| Hyperbranched | 11.76 | 11.76 | 11.76 | 11.76 | 11.76 |
| copolyester⁸ | | | | | |
| Acid Catalyst⁹ | 2 | 2 | 2 | 2 | 2 |
| Bismuth Catalyst¹⁰ | 0.29 | 0.29 | 0.29 | 0.29 | 0.29 |
| PART 2 | | | | | |
| Isocyanate¹¹ | 44 | 44 | 44 | 44 | 44 |
| Total | 114.33 | 113.66 | 112.78 | 112.78 | 113.34 |

Table Footnotes
¹Silane Example 1
²Silane Example 2
³Silicate Example 3
⁴Silane Example 4
⁵Resimene ® CE8230 melamine (90% solid) supplied by Solutia Inc., St Louis, MO.
⁶40% Solution in 2-ethylhexyl acetate of Tinuvin ® 384/Tinuvin ® 292 supplied by Ciba Speciality Chemicals, Tarryton, NY) 2:1 ratio.
⁷10% Disperlon ® LC 955 flow additive in aromatic hydrocarbon supplied by King Industries, Norwalk, Connecticut.
⁸85% Hyperbranched copolyester solution prepared in Polyester Example 5.
⁹Nacure ® 5543 25% amine-blocked dodecylbenzene sulfonic acid catalyst supplied by King Industries, Norwalk, Connecticut.
¹⁰Kcat ® XC 8203 68% bismuth catalyst supplied by King Industries, Norwalk, Connecticut.
¹¹Tolonate ® HDT LV 100% isocyanate trimer of hexamethylene diisocyanate from Rhodia, Inc, Cranbury, New Jersey.

For each of the clearcoat examples, the constituents of Part 1 were charged into a mixing vessel in the order shown above and mixed then Part 2 was premixed and charged into the mixing vessel and thoroughly mixed with Part 1 to form each of the clearcoat Examples 1-4 and the Comparative Example.

The Resulting clear coating compositions of Examples 1-4 had solid contents of 85-87% and VOC of 0.14-0.64 kg/L (1.16 -1.33 lbs/gal).

For each clearcoat prepared above, a phosphatized steel panel was coated with a primer of a Cormax® 6 electrodeposited primer (from DuPont Company) baked at 182° C. for 17 min., a waterbome primer surfacer baked at 163° C. for 30 min, and a waterbome black basecoat prebaked at 83° C. for 5 min to a dry thickness of 15.2 micrometer (0.6 mil). The panel was then topcoated with the clear coating composition of Examples 1-4 and the Comparative Example and baked at 140° C. for 30 min to a dry film thickness of 51 micrometer (2 mil).

The test results are summarized in the Table below.

TABLE 1
Properties of Coating Compositions of Examples 1-4 and
Comparative Example (Control)

| | | | | | Comparative |
|---|---|---|---|---|---|
| | Example 1 | Example 2 | Example 3 | Example 4 | Ex. |
| Property | | | | | |
| Gloss | 94 | 92 | 93 | 92 | 95 |
| QMS | 78 | 78 | 77 | 77 | 79 |
| Tukon Hardness (knoop) | 11.4 | 11.9 | 12.1 | 7.1 | 12 |
| Crockmeter Wet Mar | 93% | 90% | 93% | 95% | 90% |
| resistance | | | | | |
| Crockmeter Dry Mar | 96% | 98% | 98% | 98% | 93% |
| resistance | | | | | |
| No-Sand Recoat Adhesion | No Failure | No Failure | No Failure | No Failure | No Failure |
| (154 C. × 1 h + 130 × 30 min) | | | | | |
| Quick Knife MVSS | | | | | |
| Windshield Adhesion Test | | | | | |
| Initial | 100%(CF)/ | 100%(CF)/ | 100%(CF)/ | 100%(CF)/ | 0%(CF)/ |
| | 0%(AF) | 0%(AF) | 0%(AF) | 0%(AF) | 100% (AF) |
| after humidity (7days at | 100%(CF)/ | 100%(CF)/ | 100%(CF)/ | 100%(CF)/ | 0%(CF)/ |
| room temp.) | 0%(AF) | 0%(AF) | 0%(AF) | 0%(AF) | 100% (AF) |

The results indicate that Clearcoat Examples 1-4 exhibit 100% cohesive failure within the windshield adhesive, while the clearcoat Comparative Example not containing a silane compound of this invention exhibits 100% adhesion failure between the windshield adhesive and the clearcoat layer.

Various other modifications, alterations, additions or substitutions of the compositions of this invention will be apparent to those skilled in the art without departing from the spirit and scope of this invention. This invention is not limited by the illustrative embodiments set forth herein, but rather is defined by the following claims.

1. A coating composition comprising about 45 to 100% by weight of a film-forming binder and correspondingly 0 to 55% by weight of a volatile organic liquid carrier; wherein the binder contains:
(A) a curable film-forming hydroxyl containing highly branched polyester resin;
(B) an organic polyisocyanate crosslinking agent; and
(C) a silane fimctional component having one or more hydrolyzable silyl groups.

2. The coating composition of claim 1 wherein the binder further contains (D) a melamine crosslinking agent.

3. The coating composition of claim 1 wherein the binder further contains (E) a non-aqueous dispersed polymer.

4. The coating composition of claim 1 or 2 wherein the silane functional component is a silyl-containing acrylic polymer having a 500-5,000 number average molecular weight, which is the polymerization product of about 0-95% by weight ethylenically unsaturated non-silane containing monomer(s) and about 5-100% by weight of ethylenically unsaturated silane-containing monomers, the all percentages being based on the total weight of the polymer.

5. The coating composition of claim 1 or 2 wherein the silane functional component is:
the reaction product of a polyol of the formula
R¹—(OH)ₙ
with
(SiXₙY₄)ₙ
the reaction product having a number average molecular weight less than about 5000;
wherein:
R¹ is selected from the group consisting of
a) C₂ to C₂₀ alkyl, C₃ to C₂₀ cycloaliphatic or C₆ to C₂₀ cycloaromatic rings, each optionally substituted with at least one member selected from the group consisting of O, N, P and S;
b) two or more cycloaliphatic or aromatic rings connected to each other through a covalent bond or through an alkylene group of 1 to 5 carbon atoms, or through a heteroatom, or fused together to share to or more carbon atoms, each optionally substituted with at least one member selected from the group consisting of O, N, P and S; and
c) linear polyester, branched polyester, linear and branched polyester, polyacrylate, polyolefin, polyether, polycarbonate, polyurethane, or polyamide;
X is independently selected from the group consisting of alkoxy containing 1 to 20 carbon atoms, acyloxy containing 1 to 20 carbon atoms, phenoxy, halogen, amine, amide, urea, imidazole, carbamate, ketoximine, and oxazolidinone;
Y is selected from the group consisting of alkyl of 1 to 12 carbon atoms, alkoxy containing 1 to 20 carbon atoms, acyloxy containing 1 to 20 carbon atoms, phenoxy, halogen, amine, amide, urea, imidazole, carbamate, ketoximine, and oxazolidinone;
m is a positive integer of 2 or higher; and
n is 0, 1 or 2.

6. The coating composition of claim 1 or 2 wherein the silane functional component is (the reaction product of a cyclic carbonate of the formula 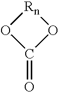
with an amino-functional silane of formula
R²NH(R³)ₘSi(OR¹)₃
the reaction product having a number average molecular weight less than about 5,000;
wherein:
R is an alkylene group;
R¹ is independently C₁-C₁₆ alkyl;
R² is independently H or C₁-C₁₂ alkyl;
R³ is a moiety independently selected from the group consisting of alkylene, cycloalkylene, heterocyclic, arylene, alkoxylene, aralkylene, alkenylene, cycloalkylene and low molecular weight polymer moiety;
n is an integer of 2 or 3; and
m is 1 to 16.

7. The coating composition of claim 1 or 2 wherein the silane functional component is the reaction product of a carboxylic acid of the formula
R′—C(O)OH
with an epoxy-functional silane of the formula
ZSiXₙY₃₋ₙ
the reaction product having a number average molecular weight less than about 5000;
wherein:
R′ is selected from the group consisting of
a) C₂ to C₂₀ alkyl, C₃ to C₂₀ cycloaliphatic or C₆ to C₂₀ cycloaromatic rings, each optionally substituted with at least one member selected from the group consisting of O, N, P and S;
b) two or more cycloaliphatic or aromatic rings connected to each other through a covalent bond or through an alkylene group of 1 to 5 carbon atoms, or through a heteroatom, or fused together to share to or more carbon atoms, each optionally substituted with at least one member selected from the group consisting of O, N, P and S; and
c) linear polyester, branched polyester, linear and branched polyester, polyacrylate, polyolefin, polyether, polycarbonate, polyurethane, or polyamide;
X is independently selected from the group consisting of alkoxy containing 1 to 20 carbon atoms;
Y is selected from the group consisting of alkyl of 1 to 12 carbon atoms, alkoxy containing 1 to 20 carbon atoms;
Z is an epoxy group containing C₃ to C₂₀ carbon atoms, optionally substituted with O or P; and
n is 0 or 1.

8. The coating composition of claim 1 or 2 wherein the silane functional component is one or more of silyl compounds in claims 4, 5, 6 and 7.

9. The coating composition of claim 1 wherein said composition is a clearcoat for a colorcoat/clearcoat finish.

10. The coating composition of claim 1 in which said composition is supplied as a two-pack composition.

11. The coating composition of claim 1 having a VOC of less than 1.5 lbs/gal.

12. The coating composition of claim 1 having a solids content greater than 80%.

13. A substrate coated with the composition of claim 1.

14. An automobile or truck exterior body coated with the dried and cured coating of claim 1.

15. A method for obtaining primerless windshield sealant adhesion over a basecoat/clearcoat finish in which the original clearcoat comprises a cured polyurethane finish, which method comprises:
(a) applying a basecoat composition to a substrate;
(b) applying a clearcoat composition of claim 1 or 2 over said basecoat;
(c) curing the basecoat/clearcoat finish; and
(d) applying directly to the cured basecoat/clearcoat finish a windshield sealant containing alkoxysilane groups.
